(19) United States
(12) Patent Application Publication
(10) Pub. No.: US 2020/0184425 A1
(43) Pub. Date: Jun. 11, 2020

(54) SYSTEM AND METHOD FOR SCREENING CANDIDATES AND INCLUDING A PROCESS FOR AUTOBUCKETING CANDIDATE ROLES

(71) Applicant: O5 SYSTEMS, INC., Toronto (CA)

(72) Inventors: Somen Mondal, Toronto (CA); Shaun Christopher Ricci, Toronto (CA); Matthew David Sergeant, East York (CA); Nemanja Stefanovic, Toronto (CA)

(21) Appl. No.: 16/227,496

(22) Filed: Dec. 20, 2018

Related U.S. Application Data
(63) Continuation-in-part of application No. 16/211,519, filed on Dec. 6, 2018.

(51) Int. Cl. G06Q 10/10; G06Q 10/06; G06F 16/28

(52) U.S. Cl. CPC G06Q 10/1053; G06F 16/285; G06Q 10/063112

(57) ABSTRACT

A computer system and computer-implemented method for screening potential candidates for an employment position or other role or function wherein the employment position is categorized according to one or more pre-determined job buckets.

### RELATED APPLICATIONS

The present application is a U.S. Continuation in Part of U.S. application Ser. No. 16/211,519, filed on 6 Dec. 2018, the entirety of which is incorporated herein by reference.

### FIELD OF THE INVENTION

The present invention relates to computer systems and more particularly, to a system and method for screening potential candidates for an employment position or other role and including an auto-bucketing process for grouping similar jobs or roles.

### BACKGROUND OF THE INVENTION

A business organization typically has multiple roles or job positions. For a large enterprise, such as a corporation or multi-national corporation, the roles or positions can number in the thousands.

Applicant Tracking Systems (ATS) provide a mechanism for tracking applicants for an organization.

However, to provide the capability to group roles for applicants and/or scaling at the enterprise level, there remains a need for improvements in the art.

### BRIEF SUMMARY OF THE INVENTION

The present invention is directed to a method and system for screening potential candidates for an employment position, role, or other function and including an autobucketing process for grouping similar jobs or roles in a database system, for example, an Applicant Tracking System (ATS).

According to an embodiment, the present invention comprises a computer system for determining suitability of a candidate for a selected role in an organization, the system comprises: a processor operatively coupled to a database and including an input component configured to retrieve data associated with an ideal candidate, the data including historical data; the processor including a component configured to generate an ideal candidate profile based on the ideal candidate data and the historical data associated with the ideal candidate; the processor including another input component configured to input application data associated with the candidate, the application data including a job description; the processor including a component configured to determine if the job description fits one of a plurality of pre-defined job buckets associated with the organization, and the processor including another component for generating a new job bucket if the job description fails to match one of the plurality of pre-defined job buckets; the processor including a component configured to generate a profile for the candidate based on the inputted data; and the processor including a comparison component configured to compare the candidate profile to the ideal candidate profile, and a component configured to generate a suitability rating for the selected role based on the comparison.

According to an embodiment, the present invention comprises a computer-implemented method for categorizing a selected job role in an organization, the computer-implemented method comprising the steps of: inputting data for the selected job role from a database associated with the organization; comparing the inputted job data with one or more pre-determined job buckets existing in the organization; if the inputted job role matches one of said pre-determined job buckets, then adding the inputted job role to the matching pre-determined job bucket; creating a new job bucket if said inputted job role fails to match one of the pre-determined job buckets; and saving the new job bucket to the database.

According to an embodiment, the present invention comprises a computer program product for categorizing a selected job role in an organization, said computer program product comprising: a non-transitory storage medium configured to store computer readable instructions; the computer readable instructions including instructions for, inputting data for the selected job role from a database associated with the organization; comparing the inputted job data with one or more pre-determined job buckets existing in the organization; if the inputted job role matches one of the pre-determined job buckets, then adding the inputted job role to the matching pre-determined job bucket; creating a new job bucket if the inputted job role fails to match one of the pre-determined job buckets; and saving the new job bucket to the database.

Other aspects and features of the present invention will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example, embodiments of the present invention, and in which:

FIG. 1 shows in diagrammatic form an exemplary network-based configuration suitable for implementing a system and a method according to embodiments of the present invention;

FIG. 2 shows in block diagram form an exemplary implementation of a system according to an embodiment of the present invention;

FIG. 3 shows in flowchart form a process for training the system according to an embodiment of the present invention;

FIG. 4 shows in flowchart form a process executed by the system for evaluating or selecting a candidate according to an embodiment of the present invention;

FIG. 5A shows in flowchart form a process executed by the system for training the system further based on a selected candidate;

FIG. 5B shows in flowchart form a process executed by the system for training the system based on a candidate that has been dismissed;

FIG. 6A shows a process for parsing and contextualizing an exemplary resume to generate a set of tokens according to an embodiment of the present invention;

FIG. 6B shows a process for parsing and contextualizing another exemplary resume to generate a set of tokens according to an embodiment of the present invention;

FIG. 6C shows a process for evaluating a candidate based on a token set associated with an ideal candidate and a token set generated for the candidate in accordance with an embodiment of the present invention;

FIG. 7 shows in block diagram form an exemplary hardware configuration for a client or server of FIG. 1 suitable for implementing a system and a method according to embodiments of the present invention; and

FIG. 8 shows in flowchart form an auto-bucketing process according to an embodiment of the present invention.

Like reference numerals indicate like or corresponding elements or components in the drawings.

### DETAILED DESCRIPTION OF THE EMBODIMENTS OF THE INVENTION

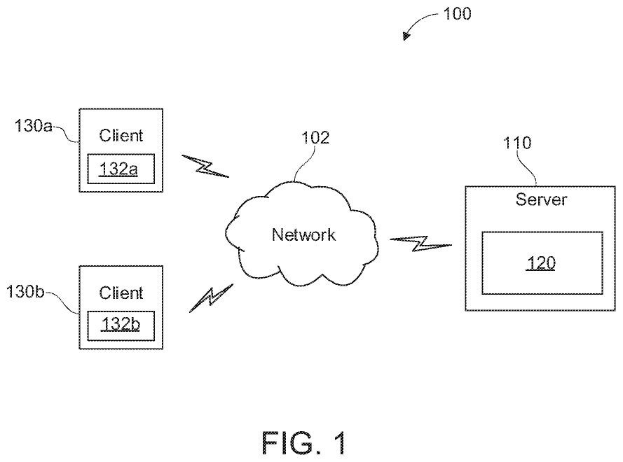

Reference is first made to FIG. 1, which shows an exemplary network-based implementation of the system for screening potential candidates for an employment position or other function based, in part, on historical data or information, and indicated generally by reference 100. The system 100 comprises a server (or one or more servers) indicated generally by reference 110 coupled to one or more client machines or computers 130, indicated individually by references 130a and 130b in FIG. 1, operatively coupled through a network indicated generally by reference 102.

The client machine or appliance 130 may include a device, such as a personal computer, a wireless communication device or smart phone, a portable digital device such as an iPad or tablet, a laptop or notebook computer, or another type of computation or communication device, a thread or process running on one of those devices, and/or an object executable by one of these devices. The server 110 may include a server application or module 120 configured to gather, process, search, and/or maintain a graphical user interface (GUI) and functionality (e.g. web pages) in a manner consistent with the embodiments as described in more detail below.

The network 102 may comprise a local area network (LAN), a wide area network (WAN), a telecommunication network, such as the Public Switched Telephone Network (PSTN), an Intranet, the Internet, or a combination of networks. According to another aspect, the system 100 may be implemented as a cloud-based system or service utilizing the Internet 102.

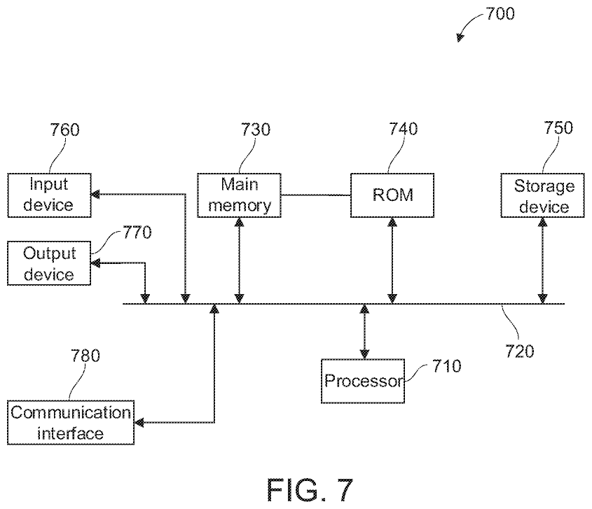

Reference is next made to FIG. 7, which shows an exemplary implementation for a client or server entity (i.e. a “client/server entity”), which may correspond to one or more of the servers (e.g. computers) 110 and/or client machines or appliances (e.g. computers) 130, in accordance with the functionality and features of the embodiments as described in more detail below. The client/server entity is indicated generally by reference 700 and comprises a processor (e.g. a central processing unit or CPU) 710, a bus 720, a main memory 730, a read only memory or ROM 740, a mass storage device 750, an input device 760, an output device 770, and a communication interface 780. The bus 720 comprises a configuration (e.g. communication paths or channels) that permits communication among the elements or components comprising the client/server entity 700.

The processor 710 may comprise a hardware-based processor, microprocessor, or processing logic that is configured, e.g. programmed, to interpret and/or execute instructions. The main memory 730 may comprise a random-access memory (RAM) or other type of dynamic storage device that is configured to store information and/or instructions for execution by the processor 710. The read only memory (ROM) may comprise a conventional ROM device or another type of static or non-volatile storage device configured to store static information and/or instructions for user by the processor 710. The storage device 750 may comprise a disk drive, solid state memory or other mass storage device such an optical recording medium and its corresponding drive or controller.

The input device 760 may comprise a device or mechanism configured to permit an operator or user to input information to the client/server entity, such as a keyboard, a mouse, a touchpad, voice recognition and/or biometric mechanisms, and the like. The output device 770 may comprise a device or mechanism that outputs information to the user or operator, including a display, a printer, a speaker, etc. The communication interface 780 may comprise a transceiver device or mechanism, and the like, configured to enable the client/server entity 700 to communicate with other devices and/or systems. For instance, the communication interface 780 may comprise mechanisms or devices for communicating with another machine, appliance or system via a network, for example, the Internet 102 (FIG. 1).

As will be described in more detail below, the client/server entity 700, in accordance with embodiments according to the present invention, may be configured to perform operations or functions relating to the process of selecting a suitable candidate, to the process of generating a candidate model or template, and the other functions as described or depicted herein. The client/server 700 may be configured to perform these operations and/or functions in response to the processor 710 executing software instructions or computer code contained in a machine or computer-readable medium, such as the memory 730. The computer-readable medium may comprise a physical or a logical memory device or medium.

The software instructions or computer code may be read into the memory 730 from another computer-readable medium, such as a data storage device 750, or from another device or machine via the communication interface 780. The software instructions or computer code contained or stored in the memory 730 instruct or cause the processor 710 to perform or execute processes and/or functions as described in more detail herein. In the alternative, hardwired circuitry, logic arrays, and the like, may be used in place of or in combination with software instructions to implement the processes and/or functions in accordance with the embodiments of the present invention. Therefore, implementations consistent with the principles of the embodiments according to the present invention are not limited to any specific combination of hardware and/or software.

Referring back to FIG. 1, each of the client machines 130 includes a client interface module 132 which is configured to provide an interface with the server 110. According to an embodiment, the client interface module 132 comprises a user interface or GUI (Graphical User Interface) which is configured to display and run one or more web or browser pages that are downloaded from the server 110 (i.e. the application module 120 running on or being executed by the server 110) and may be implemented utilizing a web browser, such Internet Explorer™ browser or the Safari™ browser. According to an embodiment, the client interface module 132 and the web pages comprise logic and processes configured to provide a user with the functionality as described in more detail herein. The particular implementation details, hardware and software, will be readily with the understanding of those skilled in the art.

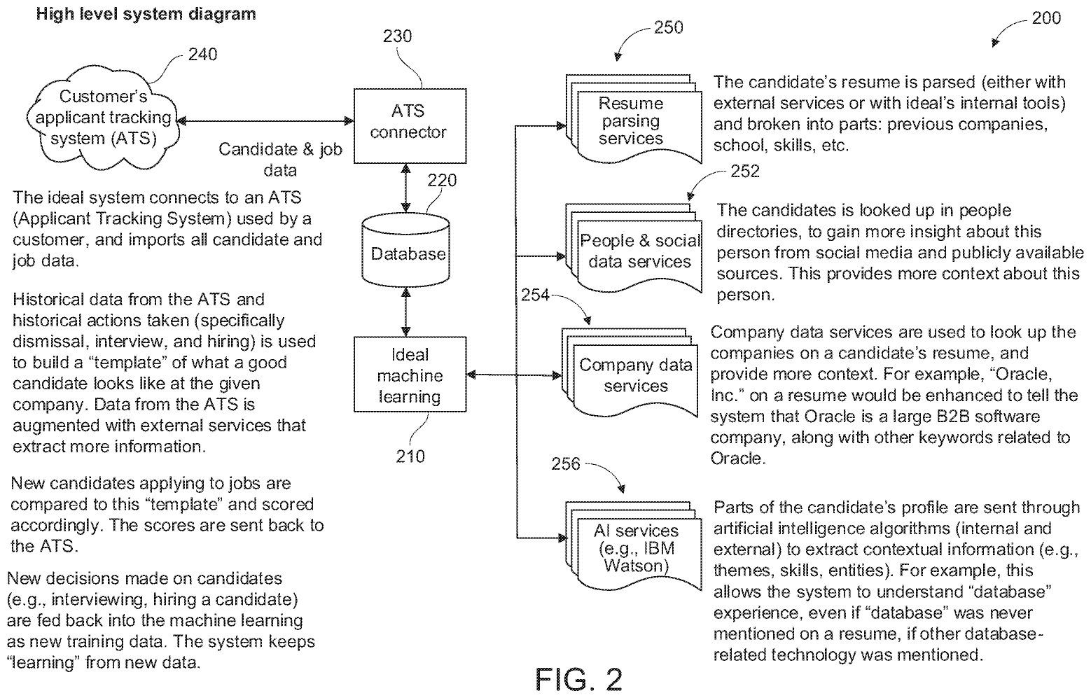

Reference is next made to FIG. 2, which shows an exemplary implementation of the system according to an embodiment of the present invention and indicated generally by reference 200. The system 200 comprises a learning machine 210, a database 220 and an interface or connector indicated by reference 230. The interface 230 is configured to couple or communicate with an external data source or repository indicated generally by reference 240. According to an exemplary embodiment, the external data source 240 comprises an Applicant Tracking System or ATS, which is configured with data and information associated with a client or customer comprising a list of applicants that have applied or have been considered for a particular job opening at a company. The applicant data includes name, contact information, resume, any questions answered during the application process, and any other information stored in the ATS 240. According to an exemplary implementation, the ATS 240 comprises historical data and historical actions. The historical data includes, for example, data/information about positions, employees and the like. The historical actions include, for example, data/information about hiring, dismissal, review, interview events or actions, and the like. For each decision, there is associated application data. The application data comprises: a candidate's resume; screening question(s) (e.g. “have you ever been convicted of a crime?”); other application questions (e.g. “are you available to work weekends?”); location information; assessment data (e.g. psychometric test data); additional information provided by the applicant, such as, the applicant's cover letter. According to another aspect, the system 200 can be configured to optionally import certain information, such as, the candidate's name and demographics, specifically for the purpose of controlling bias in the candidate model or template.

As will be described in more detail below, the system 200 is configured to generate or build an ideal candidate template or an ideal candidate model. The ideal candidate template is based on historical data imported from the ATS 240, for example, historical candidate and job data, historical action data (e.g. dismissal, interview, hiring data). The system 200 is further configured to augment the imported data from the ATS 240 with data extracted or imported from external services as described in more detail below. A machine profile or template is generated or built for a new candidate, i.e. potential hire, and compared to the ideal candidate profile and a comparison result or score is generated. The score(s) are sent or transmitted back to the ATS 240, i.e. client, and utilized in a hiring decision. The scores at the ATS 240 can be used to trigger manual or automated workflow processes, for example, contacting high score (i.e. high-grade) candidates to schedule interviews. According to another aspect, the system 200 is configured with a further learning mode or feedback mechanism. In the learning mode, the system 200 utilizes data on candidate decisions, e.g. interviews, hires, to further refine and teach the machine learning processes, as described in more detail below.

According to an exemplary embodiment and as shown in FIG. 2, the learning machine 210 is configured with a resume parsing module 250, a people or social data services module 252, a company data services module 254 and/or an artificial intelligence services module 256.

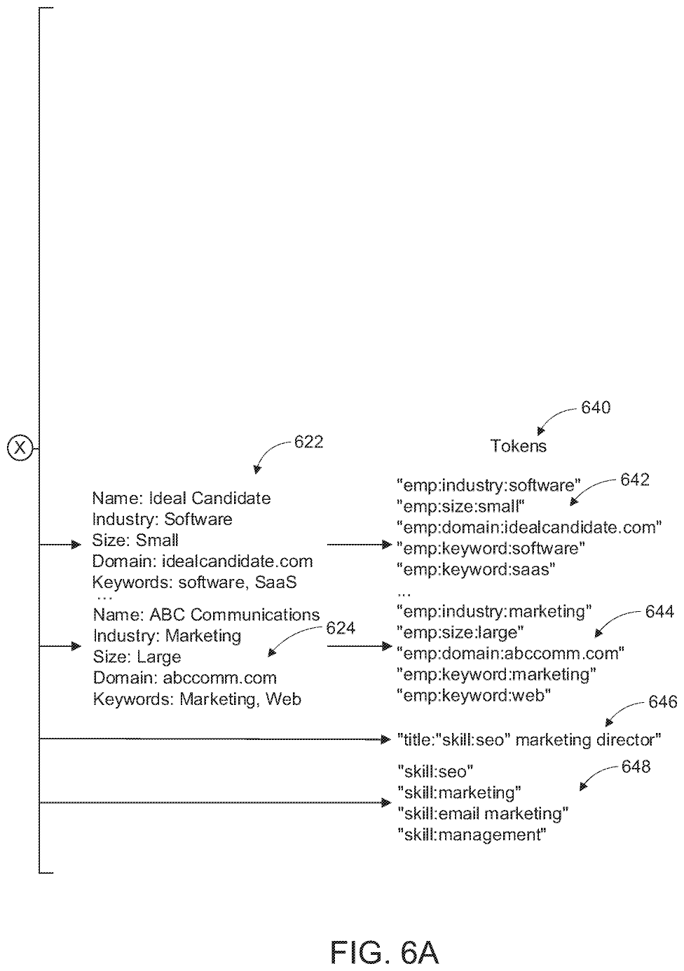

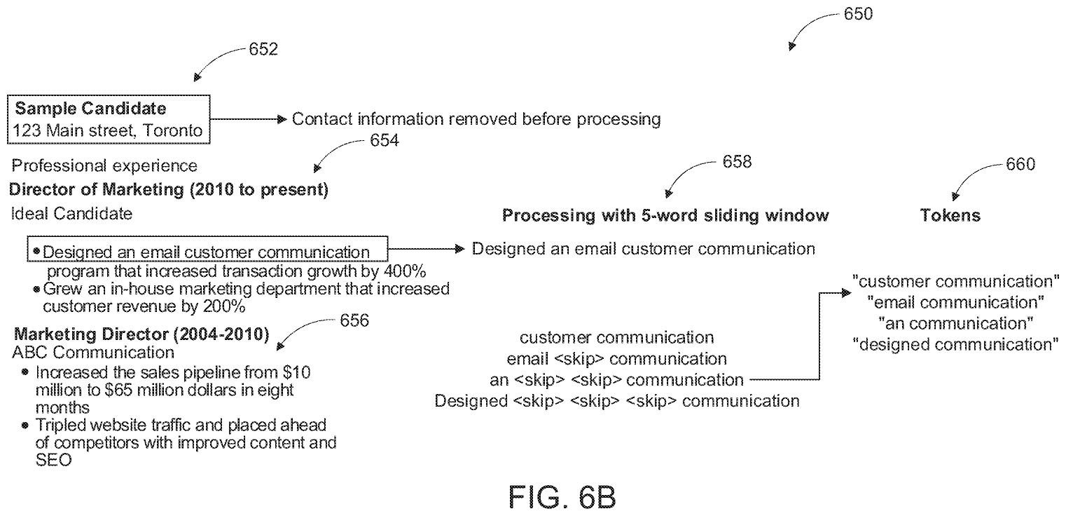

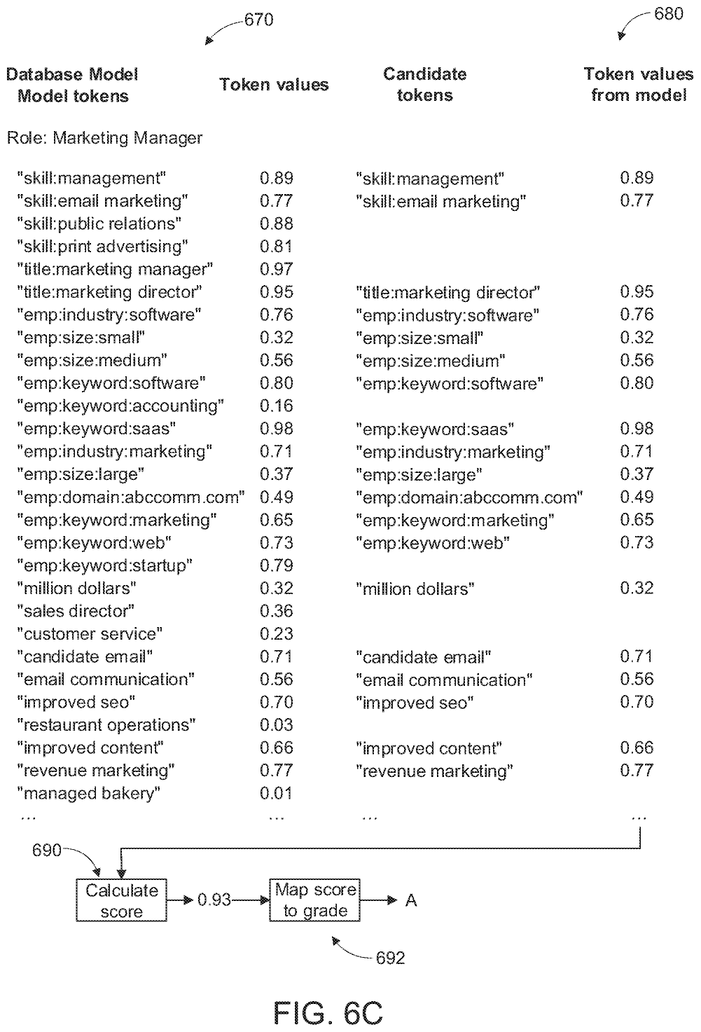

The resume parsing module 250 is configured to parse or break down a candidate's resume into useful or relevant data or information components. For example, the resume parsing module 250 is configured to break a candidate's resume down into the following parts: previous positions/companies, school(s) attended, degrees completed, skills, etc., and as described in more detail below with reference to FIG. 6A.

The people/social services module 252 is configured to search public directories or services for additional information on the candidate. The public services may comprise social media and other publicly available sources. The information obtained from such sources or services is utilized to gain additional insight on the candidate and/or provide context about the person.

The company data services module 254 is configured to examine a company or companies and other keywords appearing on a candidate's resume and provide additional information or context for the candidate. For example, if the candidate's resume lists “Oracle, Inc.”, the system is configured to interpret Oracle as a B2B software company, and other keywords describing the candidate's position at Oracle.

The AI services module 256 comprises artificial intelligence algorithms that are configured to extract contextual information about or associated with the candidate, for example, skills, entities, themes, patterns. For example, this allows the system to be configured to derive and understand a work experience as a database experience, even if the candidate has not explicitly described the experience with the term database, based on other database-related technology information being extracted from the candidate's resume.

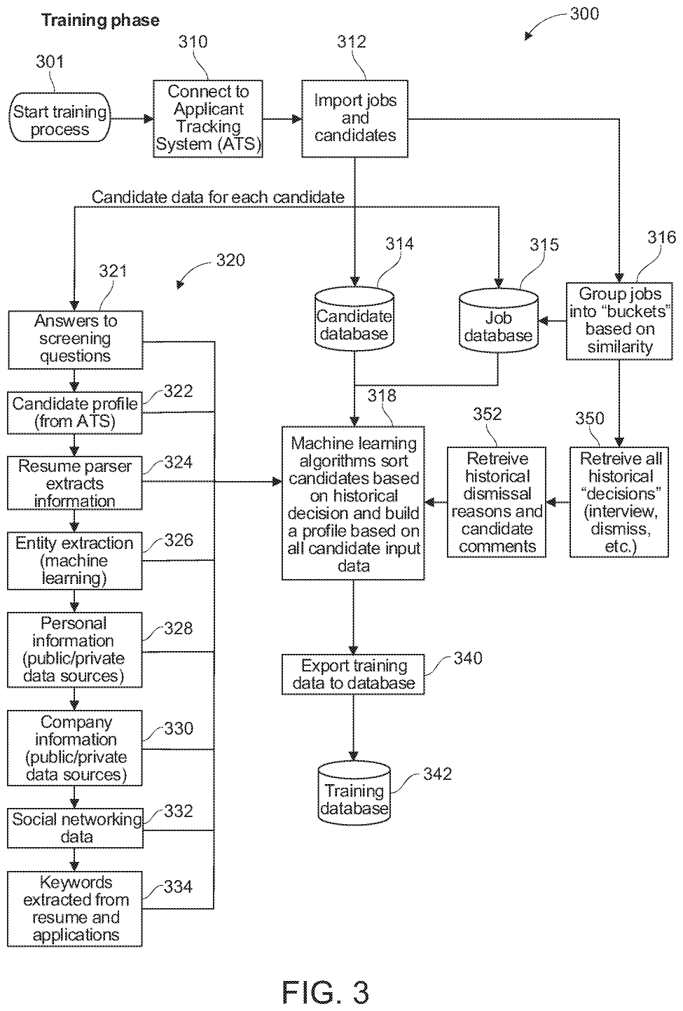

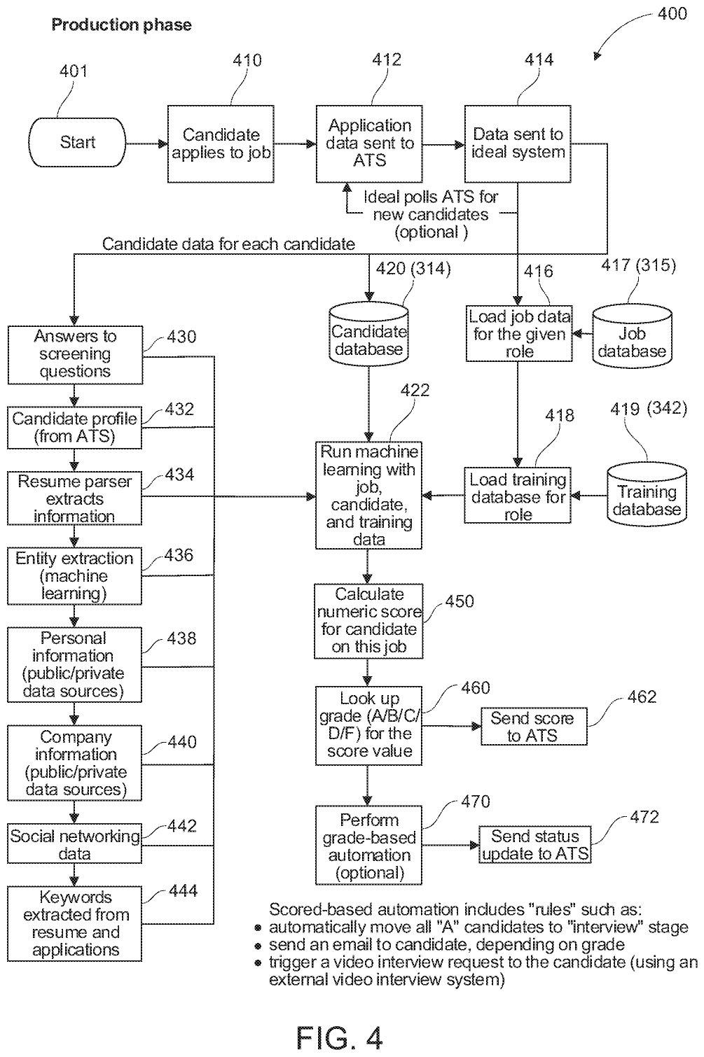

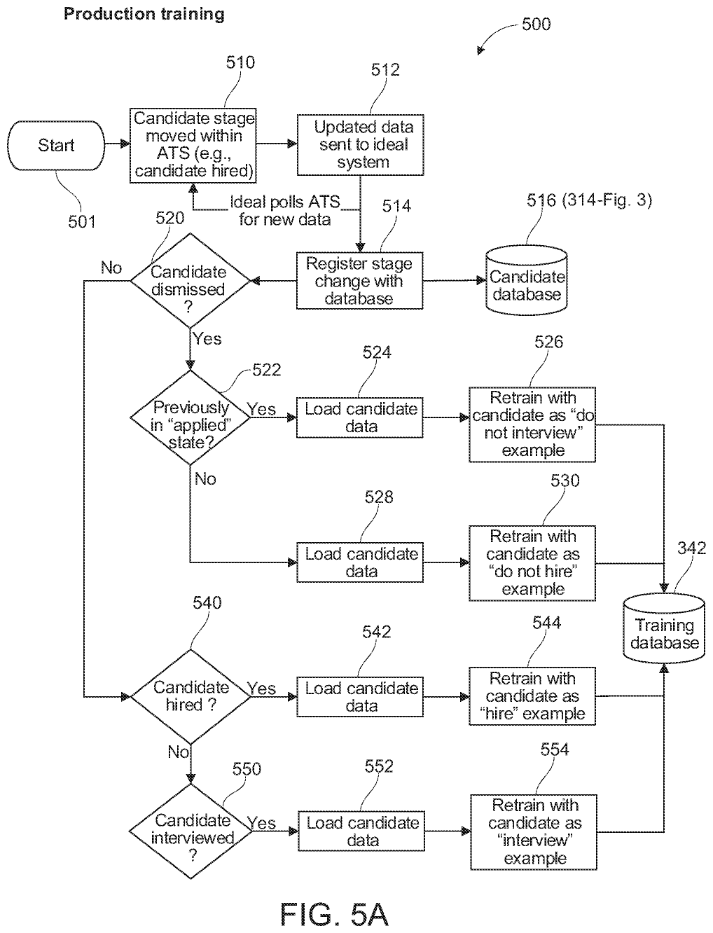

Reference is next made to FIG. 3, which shows a training process or method according to an embodiment of the present invention and indicated generally by reference 300. The training process 300 is executed by the system 200 to generate or build an ideal candidate template. The ideal candidate template comprises attributes or parameters representing what a good candidate would look like for a given company and/or a given position at the company. As described above, the system 200 utilizes data from the ATS 240 (FIG. 2) comprising historical data and historical actions taken (for example, interviewing, hiring, employee performance and/or dismissal(s)). The historical actions are characterized as decisions. According to another aspect, the system 200 is configured to associate each decision with additional application data, comprising: candidate resume; screening question(s) (e.g. Have you ever been convicted of a crime?); additional application questions (e.g. Are you available to work weekends?); location information; assessment data (e.g. psychometrics); and any additional information provided by the applicant (e.g. information or statements contained in a cover letter).

As shown in FIG. 3, the training process 300 commences execution 301 by connecting to the Applicant Tracking System (ATS) 240 (FIG. 2) 310 and importing job(s) and candidate(s) data as indicated by reference 312. The candidate data is stored in a candidate database 314 and the jobs data is stored in a job database 315. The jobs can be grouped into one or more buckets based on similarities as indicated by 316, and stored in the job database 315. Data from the candidate database 314 and the job database 315 is imported by the artificial intelligence services module 256 (FIG. 2) and machine learning algorithms are applied and executed to generate an ideal candidate template or profile as indicated by reference 318.

According to an exemplary embodiment, the machine learning algorithms 318 executed by the artificial intelligence services module 256 generate the candidate profile based on historical decision data (imported from the candidate database 314 and/or the job database 315) and candidate data for each candidate from the ATS as indicated by reference 320. According to an exemplary implementation, the candidate data 320 comprises: answers to screening questions 321; candidate profile data from the ATS 322; information extracted by the resume parser (indicated by reference 250 In FIG. 2) 324; extracted entity information 326; personal candidate information extracted or imported from public and/or private data sources 328; company information gathered or imported from public and/or private databases 330; data extracted or imported from social networking sites or services 332; and/or keywords extracted from the candidates resumes and/or job applications, as indicated by reference 334. The historical decision data, i.e. decisions, processed by the machine learning algorithms 318 comprises data on candidate interviews, dismissals, performance reviews, and the like, which is retrieved from the ATS, as indicated by reference 350. According to another aspect, the historical decision data for dismissals further includes information on the dismissal reasons and information on the candidate's comments, as indicated by reference 352. The candidate profile generated by the machine learning algorithms 318 comprises training data which is exported as indicated by reference 340 to a training database indicated by reference 342. A new candidate applying for a job is compared to the candidate profile associated with the job and subsequently scored as described in more detail below.

According to an exemplary embodiment, the Al services module 256 (FIG. 2) is implemented with machine learning algorithms comprising a Bayes Classifier. As described above, the system 200 imports applicant data from the applicant tracking system (ATS) 240. This information provides a list of applicants that have applied to the company or have been considered for a particular job at the company. The applicant data comprises: the applicant name, contact information, resume, any questions asked during the application process, answers given by the applicant during the application process, and/or any information collected or stored in the ATS 240.

Completion or execution of the training process 300 results in the generation of an ideal candidate template or data model. The ideal candidate template or data model is available for use by the system 200 as will be described in more detail below. As new candidates apply for jobs, candidate data and information are retrieved from the ATS 240 (FIG. 2) and a template or model is generated for the candidate, and the candidate model or template is compared to the ideal candidate model or template, and a score or other hiring recommendation is generated for the candidate by the system 200 as will be described in more detail below.

With reference to FIG. 6A, the system 200 is configured to receive a resume 600 from the ATS 240 and process the resume 600 with the resume parser 250. According to an exemplary embodiment, the resume parser 250 is configured to convert the resume 600 from its document format (e.g. Microsoft Word, or Adobe PDF) into a machine-readable form indicated generally by reference 610 and comprising extracted or contextualized data components or fields. According to another aspect, the imported resume is processed by a text processor to convert the resume to plain text form and remove stop words, such as “in”, “and”, and the resulting plain text is parsed and tokenized, i.e. converted into tokens 640, as described in more detail below.

According to an exemplary implementation, the extracted or contextualized data comprises: contact information 612, work experience 1 data 614, work experience 2 data 616, and skills data 618. As shown, the first work experience data 614 comprises “company name” data, which is normalized using a company database 620 resulting in a normalized company name indicated generally by reference 622. For example, Microsoft and Microsoft Corp are the same entity. The normalized name eliminates redundancy or ambiguity and provides a token 642 that is then utilized by the Bayes Classifier. The system 200 also utilizes the company database 620 to import or extract other company information, such as, company size, founding date, industry, keywords, and other company-specific information. Company data or information having variable values, for example, number of employees or founding date, are normalized into brackets, for instance, small, medium and large. The Bayes Classifier utilizes these brackets together with the absolute values.

As shown, the tokens 642 for the first company comprise: employer industry—“emp:industry:software”; employer size—“emp:size:small”; employer domain or URL—“emp:domain:idealcandidate.com”; and employer keywords—“emp:keyword:software” and “emp:keyword:saas”.

A similar process is applied to tokenize the data associated with the second work experience 616 listed in the candidate's resume to generate a normalized company name 624 and a token set 644 comprising: “emp:industry:marketing”; “emp:size:large”; “emp:domain:abccomm.com”; “emp:keyword:marketing” and “emp:keyword:web”, as shown in FIG. 6A. According to another aspect, the system 200 is configured to generate a token(s) 646 from the candidate's previous employment positions, i.e. “title:marketing director”. As shown, the skills data 618 is tokenized to generate tokens 648, which comprise individual tokens: “skills:seo”; “skill:marketing”; “skill:email marketing”; and “skill:management”. The system 200 is configured to extract and tokenize other information provided by the ATS 240, such as, a candidate's answers to screening questions during the application process.

In addition to company database or data services 622, the system 200 is configured to utilize other external databases or services. The external services comprise: people & social services; education data services; and/or artificial intelligence or AI services. The system 200 utilizes the people & social services to look up information about the individual candidate, for example, based on email address, phone number or other personally identifiable information) from social media applications and other public services that maintain information about individuals. The system 200 utilizes the company data services or database to look up each company listed on the candidate's resume in order to extract more information about the listed company, such as, the industry associated with the company, company size, company location(s), etc. The system 200 utilizes the education data services or database to look up educational institutions listed on the candidate's resume and extract information to determine the ranking of the school, the quality of the degree programs, location, etc. The system 200 utilizes the AI services to extract more information from the application data, such as, skills that are not explicitly listed in the resume of the candidate. The system 200 may also utilize AI services or functions to group candidates based on their skills and experiences.

According to another aspect, the system 200 is configured to extract or import personal information unique to the candidate, for example, email address and phone number. The system 200 utilizes the unique personal information to look up the candidate in a people information database and/or social media services. The system 200 uses these services to gather additional information about the candidate, for example, the candidate's social networking identifier, interests that the person has expressed online. The system 200 is further configured to extract and tokenize this information for further processing by the Bayes Classifier. The system 200 is

[symbol]

Following this process, the system 200 generates a token list or set for the candidate, for example, a token list as indicated by reference 680 in FIG. 6C. The token set 680 for the candidate is compared to a token list generated and associated with an ideal candidate template as described above, for example, a token list as indicated by reference 670 in FIG. 6C. The system 200 is configured to compare the tokens 670 for the ideal candidate to the tokens 680 for the candidate and calculate or generate “a score” as indicated by reference 690, for example, “0.93”. The system 200 can be further configured to map the score to a “grade” as indicated by reference 692, for example, “A”. The score 690 and/or grade 692 is then utilized by the ATS 240 to trigger a manual or automated workflows comprising contacting high-grade candidates, i.e. scores >0.80 or grades >A−, to schedule interviews. There will be instances where not all candidates will have all data points available and therefore the list of tokens 680 for a candidate may not include all tokens 670 associated with the candidate template or model, for example, as shown in FIG. 6C. The system 200 is configured to score the candidate based on the information available.

According to an exemplary implementation, the Bayes Classifier comprises a Bayesian Engine that is configured to predict outcomes based on a-priori knowledge of previous outcomes. The engine is configured to utilize heuristically developed tweaks to a pure naive Bayes engine. The tweaks include eliminating weak indicators, and implementing a custom combining algorithm to ensure that overly strong indicators do not overpower the system. These particular implementation details will be within the understanding of those skilled in the art.

It will be appreciated that a resume can result or generate several features based on the resume data that is contextualized and tokenized. According to an embodiment, the system 200 is configured with a “5-word sliding window” as depicted in FIG. 6B and indicated generally by 650.

Reference is next made to FIG. 4, which shows a production process or method for selecting a candidate according to an embodiment of the present invention and indicated generally by reference 400. The production process 400 is executed by the system 200 to compare a candidate to the ideal candidate template and generate a score or other recommendation for the candidate.

As shown in FIG. 4, when a candidate applies for a job or a new position 410, applicant data is sent and stored in the ATS 240 (FIG. 2) as indicated by reference 412. The system 200 is configured to retrieve or import the candidate's application data, and send the application data to the system 200, as indicated by reference 414. According to another embodiment, the system 200 is configured to periodically poll or contact the ATS 240 to determine if any new applicant(s) have been added. As will be described in more detail, the addition of any new applicants or candidates can be used to generate additional applicant data for comparison and/or creating an ideal candidate model or template. The candidate's application data is stored in the candidate database 314 as indicated by reference 420. As indicated by reference 416, the job data for the given role or position is also loaded. The job data is retrieved from the job database 314 (FIG. 3), as indicated by reference 417. As indicated by reference 418, training data for the given role is also loaded, for instance, from the training database 342 (FIG. 3), as shown in FIG. 4.

As depicted in FIG. 4, the system 200 is configured to execute the machine learning algorithms 318 (FIG. 3) to generate an ideal candidate profile or template based on historical decision data (imported from the candidate database 314 (FIG. 3) and/or the job database 315), and also comprising candidate data for each candidate from the candidate database 314 as indicated by reference 420. According to another aspect, the system 200 is configured to execute the machine learning algorithms 318 to process training data to further refine or revise the ideal candidate profile or template, as described in more detail below.

The machine learning algorithm module 318 is also configured to generate a candidate profile or template for the applicant as indicated by reference 422 in FIG. 4. As also shown, the machine learning algorithm module 318 is also configured to process candidate data that has been imported from the ATS and/or processed the system 200. According to an exemplary implementation as described above, the candidate data processed by the system 200 comprises: answers to screening questions 430; candidate profile data from the ATS (412) indicated by reference 432; information extracted by the resume parser (indicated by reference 250 In FIG. 2) 434; extracted entity information 436; personal candidate information extracted or imported from public and/or private data sources 438; company information gathered or imported from public and/or private databases 440; data extracted or imported from social networking sites or services 442; and/or keywords extracted from the candidates resumes and/or job applications, as indicated by reference 444.

As shown in FIG. 3, the historical decision data, i.e. decisions, processed by the machine learning algorithms 318 comprises data on candidate interviews, dismissals, performance reviews, and the like, which is retrieved from the ATS, as indicated by reference 350 in FIG. 3. According to another aspect, the historical decision data for dismissals further includes information on the dismissal reasons and information on the candidate's comments, as indicated by reference 352. The candidate profile generated by the machine learning algorithms 318 comprises training data which is exported as indicated by reference 340 to a training database indicated by reference 342. The candidate profile generated for the new candidate applying for a job is compared to the ideal candidate profile or template associated with the job and subsequently scored as described in more detail below.

According to another aspect, the system 200 is configured to classify the applicant according to the role or position being applied for by the applicant. The system 200 is configured with a number of buckets, each bucket corresponding to or being associated with a role or position. The role or position is further characterized by an ideal candidate profile or template, which is generated as described above. The candidate's applicant is assigned to the relevant ideal candidate profile or template corresponding to the associated bucket.

The candidate profile is compared to the ideal candidate profile or template associated with the job bucket, and a numeric score is generated, for instance, as described above with reference to FIG. 6C, and indicated by reference 450 in FIG. 4. The system 200 is configured to assign, i.e. through a look-up table, a grade for the score value, comprising a letter grade, A/B/C/D/F, as indicated by reference 460. The system 200 may be configured to send the score to the ATS, as indicated by reference 462 in FIG. 4.

According to another embodiment, the system 200 may further include a grade-based automation module as indicated by reference 470. The grade-based automation module is configured to provide additional functions based on the grade generated for the candidate. According to an exemplary embodiment, the grade-based module 470 is configured: to automatically move “A” candidates to an interview stage; to send an email to the candidate (which may be dependent on the grade); and/or trigger or initiate a video interview request with the candidate. The video interview can be linked through an external video interview system. As indicated by reference 472, the system 200 may also be configured to send a status update based on the grade-based operation to the Applicant Tracking System 240 (FIG. 2) associated with the client or organization. According to another aspect, the system 200 is configured to process candidates utilizing other communication mechanisms or protocols. For instance, the system 200 may be configured with a SMS communication interface to process SMS candidates.

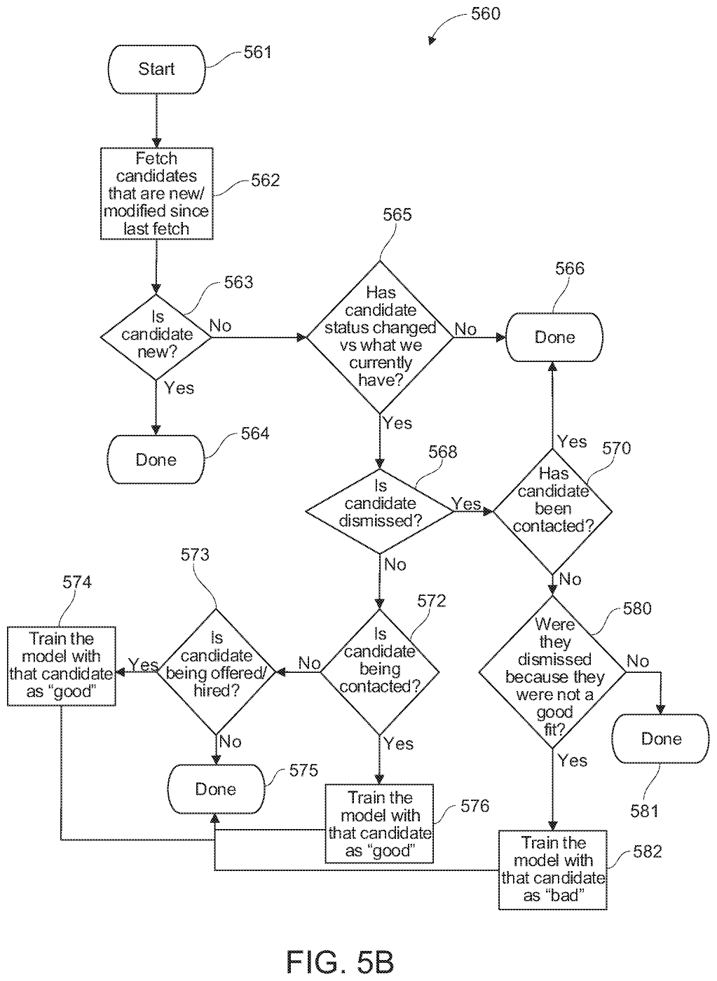

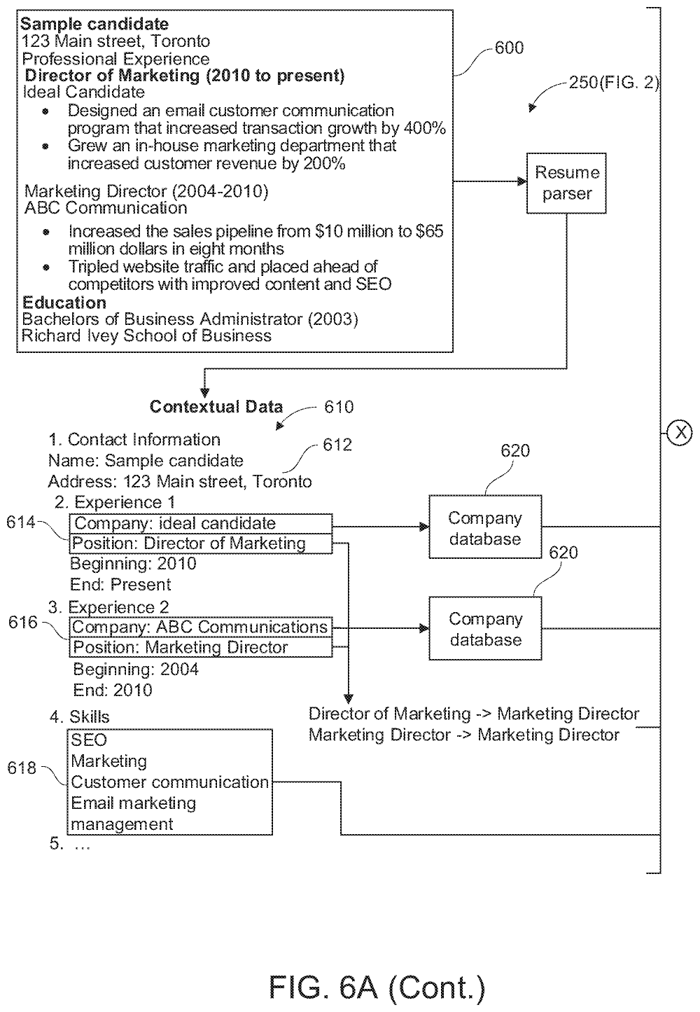

According to another embodiment, the system 200 is configured to execute a training process indicated generally by reference 500 in FIG. 5A. The training process 500 comprises feedback components and is configured to update and revise the ideal candidate profile or model based on the performance of new candidates, e.g. new candidates hired for a position or job associated with the ideal candidate profile for that job or position bucket.

As shown in FIG. 5A, the process 500 starts execution 501 with the ATS 240 (FIG. 2) being updated with decision data, e.g. selected for interview, hired, performance review, probation, dismissal, for a new candidate, as indicated by reference 510. The system 200 is configured to import or input the updated data from the ATS, as indicated by reference 512. According to an embodiment, the system 200 includes a registration module 514 configured to register a change in candidate data prior to the updated candidate data is stored or saved in the candidate database 314 (FIG. 3) as indicated by reference 516 in FIG. 5A.

As shown in FIG. 5A, the training process 200 comprises two feedback or training loops. The first feedback or training loop indicated by reference 520 is configured to process decision data associated with a candidate dismissal. The second feedback or training loop indicated by reference 540 is configured to process decision data associated with a candidate hire. As will be described in more detail below, the feedback loops 520, 540 are configured to further train the machine learning algorithms implemented or embodied in the machine learning module 210 (FIG. 2).

The first feedback training loop 520 is configured to process decision data for candidate dismissal(s). As shown, the feedback training loop 520 comprises a decision block 522 configured to determine if the decision data corresponds to a previous dismissal for the candidate. If yes, then the candidate data is retrieved from the candidate database 314, as indicated by reference 524, and the machine learning algorithms are retrained with the data characterized or tagged a “do not interview”, as indicated by reference 526, and based on the premise that an organization does not necessarily want to grant an interview to a candidate hire that was previously dismissed. The processed candidate data is stored in the training database 342 as shown in FIG. 5A. According to another aspect, the ideal candidate profile or model for the role (or a job bucket) is regenerated based on the additional decision data. If the determination in decision block 522 is no or false, then the candidate data is retrieved from the candidate database 314, as indicated by reference 524, and the machine learning algorithms are retrained with the data characterized or tagged a “do not hire”, as indicated by reference 530. The processed candidate data is stored in the training database 342, for example, as described in more detail below with reference to FIG. 5B.

The second feedback training loop 540 is configured to process decision data for candidate hire(s). As shown, the feedback training loop 540 comprises a decision block configured to determine if the decision data corresponds to a candidate that was hired, for example, by the organization. If yes, then the candidate data is retrieved from the candidate database 314, as indicated by reference 542, and the machine learning algorithms are retrained with the data characterized or tagged as a “hire”, as indicated by reference 544. The processed candidate data corresponding to the hire decision data is stored in the training database 342. According to another aspect, the ideal candidate profile or model for the role (or a job bucket) is regenerated based on the additional decision data. If the candidate is not a hire, the feedback training loop 540 includes another decision block to determine if the decision data is for a candidate who was interviewed, as indicated by reference 550. If yes, then the candidate data is retrieved from the candidate database 314, as indicated by reference 552, and the machine learning algorithms are retrained with the data characterized or tagged an “interview”, as indicated by reference 554 in FIG. 5A. The processed candidate data is stored in the training database 342.

Reference is next made to FIG. 5B, which shows in flowchart form a training process according to another aspect. The training process is indicated generally by reference 560 and configured to further train, i.e. update and revise, the ideal candidate profile or model based on a candidate that is a “good candidate”, or a “bad candidate”, i.e. a candidate that has been dismissed, fired or otherwise terminated.

As shown in FIG. 5B, the training process 560 starts execution 561 and the first operation comprises fetching candidates that are new/modified since a last fetch (i.e. from the candidate database 314 in FIG. 3). In decision block 563, the training process 560 determines if the candidate is new. If the fetched candidate is a new candidate, then execution terminates as indicated by reference 564. If the candidate is not new, then the process 500 is configured to determine if the candidate status has changed in decision logic block 565. If the candidate status has not changed, for instance, the candidate is still an employee and has not been dismissed, then the training process 560 finishes execution as indicated by reference 566. If it is determined that the candidate status has changed (decision block 565), the training process 560 is configured with a decision logic block 568 to determine if the change in candidate status is a dismissal. For a dismissed candidate, the training process 560 may include a decision logic block to determine if the candidate has been contacted, for example, for additional information concerning the employment and/or dismissal, and if yes, then training process 560 terminates or completes execution in step 566. The next processing step executed in the training process 560 comprises a decision logic block 580 configured to determine if the candidate was dismissed because they were not “a good fit”. If no or false, then the training process 560 terminates as indicated by block 581. If, on the other hand, the candidate was not a good fit (as determined in decision block 580), the training process 560 is configured to execute a process as indicated by reference 582 for further training the ideal candidate model based on information and data for the dismissed candidate, e.g. a candidate that was not “a good fit”. Following the execution of the training operations, the training process 560 terminates or completes execution as indicated by reference 575.

Referring still to FIG. 5B, if the candidate status has changed (decision block 565), but the candidate has not been dismissed (decision block 568), then the training process 560 is configured with a processing stream or loop configured to further train the ideal candidate model with what constitutes a “good fit” candidate. According to an exemplary implementation, the training process 560 includes a decision block configured to determine if the candidate has been contacted, for example, the candidate has been hired, as indicated by reference 572. If yes, then the training process 560 is configured to further train the ideal candidate model based on candidate information and data associated with a candidate that is a “good fit”. The training process 560 then terminates or ends execution as indicated by reference 575. If, on the other hand, the candidate is not being contacted (decision block 572), but rather the candidate is being hired or being given an offer of employment as determined in decision block 573, then the training process 560 is configured to further train the ideal candidate model based on information and data on the candidate which constitutes a “good candidate” or a “good fit”, as indicated by reference 574 in FIG. 5B. Once the training operations area completed, the training process 560 terminates execution as indicated in block 575.

It will be appreciated that the feedback loop(s) comprising the training process 500 function to improve and revise the ideal candidate profile or template over time, based on the needs of the organization or business, changes to the role or position itself, and/or as more decision data concerning candidate(s) for the role is collected.

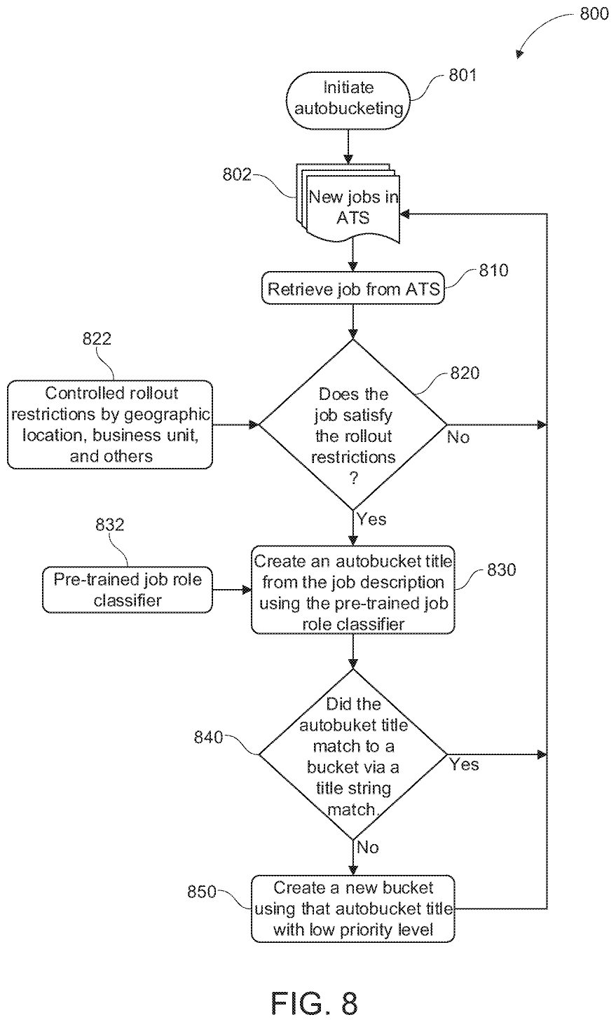

Reference is next made to FIG. 8, which shows in flowchart form an auto-bucketing process according to an embodiment of the present invention and indicated generally by reference 800. The auto-bucketing process 800 is configured to execute on a computer system with at least one or more hardware processors and execution is initiated as indicated by reference 801.

According to an embodiment, the auto-bucketing process 800 commences execution by retrieving jobs or roles that have been saved or posted to the Applicant Tracking System (ATS) 802 as indicated by reference 810 in FIG. 8. According to one embodiment, the system is configured to retrieve new jobs or roles that have not been previously processed, i.e. “bucketed”. Each job is retrieved until there are no new jobs or roles left to retrieve from the ATS 802. If new jobs or roles are added to the ATS 802, then the system is further configured to retrieve the new job(s) or role(s) and execute the auto-bucketing process as described in more detail below. According to an exemplary implementation, the system is configured to execute the auto-bucketing process 800 periodically or continuously until disabled.

As shown in FIG. 8 and indicated by reference 830, the auto-bucketing process 800 is configured to create an auto-bucket for a job or a role. According to an embodiment, the auto-bucketing process 800 creates an auto-bucket title based on the description associated with the job or role. The auto-bucketing process 800 is configured to use the generated auto-bucket titles against existing job or role buckets as indicated in decision block 840. According to an exemplary implementation, the auto-bucketing process 800 comprises a string matching mechanism which is configured to compare the generated auto-bucket title against job title buckets. If the generated title matches an existing job title bucket, then the job or title is associated with or added to the existing job bucket as indicated in decision step 840. If on the other hand, the generated auto-bucket title does not match or fall into an existing job bucket, the auto-bucketing process 800 creates a new job title bucket which is configured in the ATS (e.g. implemented in a database or computer memory), and corresponds to the generated auto-bucket title, as indicated by reference 850 in FIG. 8. In subsequent executions of the auto-bucketing process 800, the generated auto-bucket title will also be compared to the new job title bucket. According to another aspect, the auto-bucketing process 800 assigns a low priority to the new job title bucket as also indicated in block 850. According to this embodiment, the newly generated job bucket(s) are assigned a low priority so that existing job title buckets have a higher priority over the autogenerated job title bucket(s).

According to an exemplary implementation, the auto-bucketing process 800 comprises a pre-trained job role classifier as indicated by reference 832 in FIG. 8. The classifier may be implemented, for example, in a naive Bayes classifier. The classifier is trained utilizing a pre-determined or internal dataset comprising a plurality of data sources. The classifier is configured to generate to generate a title for the job or role. The particular implementation details will be readily within the understanding of one skilled in the art.

According to another embodiment, the auto-bucketing process 800 includes a job rollout determination or mechanism indicated generally as a decision step 820. The job rollout determination 820 is configured to determine if the job retrieved from the ATS 802 in processing step 810 is subject to any rollout restrictions or settings. According to an embodiment, the auto-bucketing process 800 is configured to restrict the creation of job or role buckets according to predetermined criteria, as indicated by reference 822, and including for instance, job location, business unit, and other criteria. If the job is subject to any rollout restrictions and the rollout restrictions are satisfied as determined in decision logic step 820, then a corresponding auto-bucket job title is generated in step 830 and the processing continues, as described above. If, on the other hand, the retrieved job does not satisfy the rollout restrictions, then the auto-bucketing process 800 loops back and the retrieved job is matched to any existing job bucket(s) using a standard job to bucket association process instead of the auto-bucketing process as described above. It will be appreciated that this functionality provides the system with the capability to roll-out business segment or departmental hiring or expansion in organization, particularly, large organizations, in a controlled manner.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A computer system for determining suitability of a candidate for a selected role in an organization, said system comprising:
a processor operatively coupled to a database and including an input component configured to retrieve data associated with an ideal candidate, said data including historical data;
said processor including a component configured to generate an ideal candidate profile based on said ideal candidate data and said historical data associated with said ideal candidate;
said processor including another input component configured to input application data associated with the candidate, said application data including a job description;
said processor including a component configured to determine if said job description fits one of a plurality of pre-defined job buckets associated with the organization, and said processor including another component for generating a new job bucket if said job description fails to match one of said plurality of pre-defined job buckets;
said processor including a component configured to generate a profile for the candidate based on said inputted data; and
said processor including a comparison component configured to compare said candidate profile to said ideal candidate profile, and a component configured to generate a suitability rating for the selected role based on said comparison.

2. The computer system as claimed in claim 1, wherein said component comprises a component configured to extract a string associated with said inputted job role and comparing said inputted job role string to a string associated with each of said one or more pre-defined job buckets.

3. The computer system as claimed in claim 2, further including a component configured to determine if there are one or more restrictions on the creation of a new job bucket, and said component being responsive to said one or more restrictions and being configured to perform a best match between said inputted job role and one of said one or more pre-defined job buckets.

4. The computer system as claimed in claim 3, wherein said one or more restrictions comprise geographical location of the selected role, business unit of the organization.

5. A computer program product for categorizing a selected job role in an organization, said computer program product comprising:
a non-transitory storage medium configured to store computer readable instructions;
said computer readable instructions including instructions for, inputting data for the selected job role from a database associated with the organization;
comparing said inputted job data with one or more pre-determined job buckets existing in the organization;
if said inputted job role matches one of said pre-determined job buckets, then adding said inputted job role to said matching pre-determined job bucket;
creating a new job bucket if said inputted job role fails to match one of said pre-determined job buckets; and
saving said new job bucket to said database.

6. The computer program product as claimed in claim 5, wherein said step of comparing comprises extracting a string associated with said inputted job role and comparing said inputted job role string to a string associated with each of said one or more pre-determined job buckets.

7. The computer program product as claimed in claim 5, further including determining if there are one or more restrictions on the creation of a new job bucket, and there are one or more restrictions, performing a best match between said inputted job role and one of said one or more pre-determined job buckets.

8. The computer program product as claimed in claim 7, wherein said one or more restrictions comprise geographical location of the selected role, business unit of the organization.

9. The computer program product as claimed in claim 7, wherein said step of creating a new job bucket comprises generating a job bucket title based on a description of the selected role utilizing a pre-trained job role classifier.

10. The computer program product as claimed in claim 9, wherein said new job bucket is assigned a lower priority in relation to said one or more predetermined job buckets.

11. A computer-implemented method for categorizing a selected job role in an organization, said computer-implemented method comprising the steps of:
inputting data for the selected job role from a database associated with the organization;
comparing said inputted job data with one or more pre-determined job buckets existing in the organization;
if said inputted job role matches one of said pre-determined job buckets, then adding said inputted job role to said matching pre-determined job bucket;
creating a new job bucket if said inputted job role fails to match one of said pre-determined job buckets; and
saving said new job bucket to said database.

12. The computer-implemented method as claimed in claim 11, wherein said step of comparing comprises extracting a string associated with said inputted job role and comparing said inputted job role string to a string associated with each of said one or more pre-determined job buckets.

13. The computer program product as claimed in claim 11, further including determining if there are one or more restrictions on the creation of a new job bucket, and there are one or more restrictions, performing a best match between said inputted job role and one of said one or more pre-determined job buckets.

14. The computer program product as claimed in claim 13, wherein said one or more restrictions comprise geographical location of the selected role, business unit of the organization.

15. The computer program product as claimed in claim 14, wherein said step of creating a new job bucket comprises generating a job bucket title based on a description of the selected role utilizing a pre-trained job role classifier.

16. The computer program product as claimed in claim 12, wherein said new job bucket is assigned a lower priority in relation to said one or more predetermined job buckets.
